(19) United States
(12) Patent Application Publication
(10) Pub. No.: US 2016/0058058 A1
(43) Pub. Date: Mar. 3, 2016

(54) Processed Egg and process for producing the same

(71) Applicants: Sylvain Perron, Otterburn Park (CA); Denis Langlois, Les Cedres (CA)

(72) Inventors: Sylvain Perron, Otterburn Park (CA); Denis Langlois, Les Cedres (CA)

(21) Appl. No.: 14/476,678

(22) Filed: Sep. 3, 2014

(51) Int. Cl. A23L 1/32

(52) U.S. Cl. CPC A23L 1/32; A23V 2002/00

(57) ABSTRACT

The present invention relates to a process for processing liquid egg in order to obtain a ready to eat processed egg product hermetically contained into a container.

### FIELD OF THE INVENTION

This invention relates to a process for

### BACKGROUND OF THE INVENTION

A boiled egg itself is a foodstuff habitually eaten from ancient times, and even during the present it is frequently eaten as it is; the way of cutting has been improved, and a boiled egg is used only for ornamentation on the dining table as a garnish and thus generally remains as a commonplace foodstuff. Aside from the drawing of patterns, characters and figures on the outer surface of the eggshell, in conventional attempts to draw patterns or the like on the curved surface of the boiled egg after removal of the eggshell, coloring matters are inserted under pressure or penetrated area-selectively in some form from the outside of the eggshell through the eggshell, and the coloring matters are impregnated on the curved surface of the boiled egg to draw patterns; hence, there are dangers that microorganisms may enter through minute damaged portions of the eggshell owing to the insertion under pressure and penetration treatment of the coloring matters, or that contaminants may enter because of the treatment itself; commercialization of such drawing is thus obstructed owing to concerns about food hygiene control.

In the past, formulated cooked eggs have been formed by the filling of a mold with a liquid egg mixture and then cooking the liquid egg mixture within the mold. Many problems have arisen through the implementation of this processing methodology. Formulated fried eggs produced according to the above identified methods unfortunately have the appearance and taste of commercial processing. Frequently these food articles after cooking are extremely dense having poor viscosity. Formulated fried eggs cooked within a mold generally exhibit undesirable sensory perceptions related to the appearance, taste and texture as compared to a freshly fried egg. A need therefore exists to eliminate the dense commercial processing appearance and taste associated with a formulated fried egg product as cooked within a mold.

In the past procedures have generally not been implemented to rigorously control the processing and cooking parameters utilized to yield a formulated fried egg. A need exists to develop a formulated hardened egg which is more appealing in appearance and taste and which is susceptible to freezing and reheating within a conventional or microwave heating prior to consumption by an individual.

In the past the freezing and/or extended refrigeration of a formulated fried egg has lead to a loss of a cohesive texture and the degradation of other sensory perceptions such as mouth feel, taste, elasticity, and/or the food product not being tender or appealing to an individual.

Another common problem encountered during delayed consumption, extended refrigeration and/or freezing of a formulated fried egg is that the food product exhibits syneresis, or the loss of water when frozen and reheated, or when stored for an extended period of time.

It is also desirable to provide a formulated fried egg which is natural in appearance. In the past formulated fried eggs have included a symmetrically located egg yolk portion as centrally positioned within a substantially round egg white portion. These types of formulated fried eggs do not appear to be natural. Natural fried eggs experience random yolk positioning and non-symmetrical egg white portions.

The known formulated fried egg processing techniques frequently cause freezing and/or thawing damage to frozen eggs and fail to retain the egg yolk portions in a semi-liquid state after freezing and subsequent thawing and heating. As a result the egg yolk portions of the known formulated fried eggs have not readily fractured, have not provided a semi-liquid state, nor have provided a desired elastic texture.

### SUMMARY OF THE INVENTION

One aim of the present invention is to provide a process for processing egg product, said process comprising the steps of:
a. cooling pasteurised liquid egg product to a temperature of 1° C. to 8° C. to obtain a cooled liquid pasteurised egg product;
b. putting said cooled liquid pasteurised egg product of step a) into a hermetically closed container. It will be understood by the person skilled in the art of the present invention that the liquid pasteurised egg product can be pre-heated to a temperature of 25° C. to 55° C. before being put in the container.
c. eating said container of step b) containing said liquid pasteurised egg product to a temperature inducing hardening of said egg product to obtain hardened egg product; and
d. cooling said hardened egg product of step c) to a temperature of 1° C. to 10° C.

The egg product may be whole liquid egg or a part thereof. The egg part can be the white part or the yolk part of the egg. The white part or yolk part can be used alone or together into different ratios depending on the needs.

The cooling of step a) can be performed to a temperature of 1° C. to 6° C., but is preferably at 4° C.

The heating of step c) can be performed to a temperature of 60° C. to 110° C., but preferably at a temperature of 70° C. to 80° C. for a period of tie allowing hardening of the egg product. Preferably, the eating step results in completely hardening of the egg product.

The eating of step c) can be performed for a period of time of 5 to 60 minutes but preferably of 10 to 50 minutes.

In accordance with the present invention there is provided a processed egg product produced by the process or a variant thereof of the present invention.

### DETAILED DESCRIPTION OF THE PREFERRED EMBODIMENT

The present invention now will be described more fully hereinafter with reference to the accompanying drawings, in which preferred embodiments of the invention are shown. This invention, may, however, be embodied in many different forms and should not be construed as limited to the embodiments set forth herein, rather, these embodiments are provided so that this disclosure will be thorough and complete, and will fully convey the scope of the invention to those skilled in the art.

According to the preferred embodiment of the invention, there is provided a process for producing molded egg mixture having different ratios of egg whites and yolks. The proportion of whites and yolks can vary according on the targeted group of consumers.

The process invention comprises steps of providing liquid egg or liquid egg part such as whites or yolks. The liquid egg is preferably previously pasteurized to avoid any microbial contamination. The liquid egg is then cooled at a temperature of about 1° C. to 8° C., but preferably 4° C. to 6° C. The pasteurized liquid egg can be in another embodiment kept warm, for example but not limited to, to a temperature of 20° C. to 60° C.

One embodiment of the invention provides processed egg product composed of only egg whites.

Another embodiment of the invention provides processed egg product with only egg yolks.

In yet another embodiment, whites and yolks are provided together into a processed egg product. Whites and yolks can be homogenously mixed in different ratios, or alternatively spatially distributed into the processed egg product of the invention in manner to be visually able to distinctly see each part therein the processed egg product.

The liquid egg is then put into a container. The container is then hermetically closed to avoid lost of egg product or passage of microbes and/or air into the container. Preferably the container is a tubular plastic bag, which can have different forms and size to give the final processed egg product the appearance desired by the customers. For example, but not limited to, the bag can give the processed egg product the form of a ball, a square, a tube, elongated or short, or any other artistic form such as an animal, a car, or a clown. It will be recognized by the person skilled in the art of the invention that the container can be made of any metal, plastic, or any other material approved in food preparation.

The heating of the container is performed in manner to induce hardening, or coagulation, of the liquid egg product into the hermetically closed, or sealed, container. The hardening of the processed egg product may vary by heating at different temperature above 60° C. for different periods of time. According to the invention, the heating step is preferably performed at a temperature of 60° C. to 110° C., and more preferably at a temperature of 70° C. to 100° C. The person skilled in the art of the invention will understand that heating may take place through different methods such as microwave, electric pulse, radio frequency (RF), or ohmic heating, through heat exchangers, or any other suitable heating technique. Heating the egg product and container can be achieved at pasteurization temperature.

Package size has no effect on the time the filled container must be held at a pasteurization temperature. Instead, preheating both the package container and the egg product allows the pasteurization process to be completed in package in substantially the same period of time regardless of the package size.

Following heating, the containerized product is rapidly cooled at a rate sufficient to refrigerate the egg product in the container in order to inhibit germination of bacterial spores therein. Agitation may be applied to the containers during the cooling of the prior heating steps in order to release or distribute heat evenly throughout the package and product. The packaged egg product may then be shipped or stored while refrigerated or at room temperature. It has been found that the process of the present invention produces a processed egg product with an extended shelf life without the restraints of aseptic packaging. Moreover, production throughput is significantly increased.

One embodiment of the present invention is to have packaged egg product having extended shelf life at room temperature. Effectively, the egg product obtained through the present process invention can be kept at a room temperature of 10° C. to 25° C. for a period extending up to 3 months.

The processed egg product of the present invention may include seasonings, such as salt, pepper, flavoring and/or coloring compounds, and/or herbs.

Other ingredients may be included to assist in preparation of processed egg product from the liquid whole egg. Such production assistance ingredients may include edible oil, such as canola oil, water, citric acid, xanthan gum, skim milk powder and modified starch. Citric acid may be added to stabilize the colour of the egg core. Gum and starch may be added to assist in moisture control during freezing and thawing.

In one embodiment of the invention, the egg may contain added omega-3 (n-3) fatty acids, vitamins, minerals, or any other healthy known product that can be mixed to a liquid whole egg or a part thereof.

The novel egg product of the present invention, therefore, is a convenient, egg snack food product that can be reheated through frying, baking or microwave for consumption. In addition to the processed egg product being provided in the form of a nugget of desired cross-sectional shape, the processed egg product may be provided in any desired shape, such as oval and egg shapes and in the form of large patties.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

The present invention will be more readily understood by referring to the following examples, which are given to illustrate the invention rather than to limit its scope.

### Example I

### Egg Bar Prepared from Refrigerated Liquid Egg

Pasteurized liquid egg is kept at 1° C. to 4° C. Mixture of herbs is added to obtain flavored liquid egg. It is then put into a small tubular part of bag, which is hermetically sealed with metal clips on both extremities. The full filled bag is then heathen at 70° C. up until the liquid egg is hardened. The hardened egg into the bags are then frozen at a temperature of between −10° C. to 0° C. into a freezer, and finally conserved at a temperature of 1° C. to 6° C.

### Example II

### Egg Bar Prepared from Prewarmed Liquid Egg

Pasteurized liquid egg is kept at 25° C. to 55° C. Mixture of herbs is added to obtain flavored liquid egg. It is then put into a small tubular part of bag, which is hermetically sealed with metal clips on both extremities. The full filled bag is then heathen at 70° C. up until the liquid egg is hardened. The hardened egg into the bags are then frozen at a temperature of between −10° C. to 0° C. into a freezer, and finally conserved at a temperature of 1° C. to 6° C.

### Example III

### Egg Bar Prepared with Delayed Heating

Pasteurized liquid egg is kept at 1° C. to 4° C. or pre-heated at between about 25° C. to 35° C. Mixture of herbs is added to obtain flavored liquid egg. It is then put into a small tubular part of bag, which is hermetically sealed with metal clips on both extremities. The full filled bag is then heathen at between about 70° C. to 100° C. up until the external surface of liquid egg is hardened. The heating step is repeated later to complete the hardening of the central part of the egg bar. This allows to get conservation period of the egg bar longer. The hardened egg into the bags are then frozen at a temperature of between −10° C. to 0° C. into a freezer, and finally conserved at a temperature of 1° C. to 6° C.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

We claim:

1. A process for processing egg product, said process comprising the steps of
a) cooling liquid egg product to a temperature of 1° C. to 8° C. to obtain a cooled liquid pasteurised egg product;
b) putting said cooled liquid egg product of step a) into a hermetically closed container;
c) heating said container of step b) containing said cooled liquid egg product to a temperature inducing hardening of said egg product to obtain hardened egg product; and
d) cooling said hardened egg product of step c) to a temperature of 2° C. to 10° C.

2. The process of claim 1, wherein said egg product is whole liquid egg or a part thereof.

3. The process of claim 2, wherein said part thereof is the white part or the yolk part of said egg.

4. The process of claim 1, wherein said liquid egg product is pasteurised liquid egg product.

5. The process of claim 1, wherein said cooling of step a) is to a temperature of 2° C. to 6° C.

6. The process of claim 1, wherein said heating of step c) is performed to a temperature of 60° C. to 110° C.

7. The process of claim 1, wherein said heating of step c) is performed to a temperature of 70° C. to 80° C.

8. The process of claim 1, wherein said heating of step c) is performed to obtain a completely hardened egg product.

9. The process of claim 1, wherein said heating of step c) is performed for a period of time from 5 to 60 minutes.

10. The process of claim 1, wherein said cooled liquid pasteurised egg product is warmed to a temperature of between about 20° C. to 35° C. before step b).

11. A processed egg product produced by the process as claimed in any one of claims 1 to 10.

12. The processed egg product of claim 11 being a ready to eat processed egg product.
